(19) United States
(12) Patent Application Publication
(10) Pub. No.: US 2022/0281133 A1
(43) Pub. Date: Sep. 8, 2022

(54) 3D PRINTING OF FULLY DENSE AND CRACK FREE SILICON WITH SELECTIVE LASER MELTING/SINTERING AT ELEVATED TEMPERATURES

(71) Applicant: SILFEX, INC., Eaton, OH (US)

(72) Inventors: Jihong CHEN, Cincinnati, OH (US); Yi SONG, Cincinnati, OH (US); Vijay NITHIANANTHAN, Springboro, OH (US)

(21) Appl. No.: 17/637,179

(22) PCT Filed: Aug. 19, 2020
(86) PCT No.: PCT/US2020/046967

§ 371 Date: Feb. 22, 2022

Related U.S. Application Data
(60) Provisional application No. 62/890,769, filed on Aug. 23, 2019.

(51) Int. Cl. B28B 1/00; B28B 17/00; B33Y 10/00; B33Y 30/00; B33Y 40/20

(52) U.S. Cl. CPC B28B 1/001; B28B 17/00; B33Y 10/00; B33Y 30/00; B33Y 40/20

(57) ABSTRACT

In a fully dense printing method, a plurality of buffer layers of silicon are initially printed on a steel substrate, and then layers of silicon for the actual component are printed on top of the buffer layers using a double printing method. In a fully dense and crack free printing method, one or more heaters and thermal insulation are used to minimize temperature gradient during Si printing, in-situ annealing, and cooling.

### CROSS-REFERENCE TO RELATED APPLICATIONS

This application claims the benefit of U.S. Provisional Application No. 62/890,769, filed on Aug. 23, 2019. The entire disclosure of the application referenced above is incorporated herein by reference.

### FIELD

The present disclosure relates generally to manufacturing silicon components and more particularly to 3D printing of fully dense and crack free silicon with selective laser melting/sintering at elevated temperatures.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A substrate processing system typically includes a plurality of processing chambers (also called process modules) to perform deposition, etching, and other treatments of substrates such as semiconductor wafers. Examples of processes that may be performed on a substrate include, but are not limited to, a plasma enhanced chemical vapor deposition (PECVD) process, a chemically enhanced plasma vapor deposition (CEPVD) process, and a sputtering physical vapor deposition (PVD) process. Additional examples of processes that may be performed on a substrate include, but are not limited to, etching (e.g., chemical etching, plasma etching, reactive ion etching, etc.) and cleaning processes.

During processing, a substrate is arranged on a substrate support such as a pedestal, an electrostatic chuck (ESC), and so on in a processing chamber of the substrate processing system. During deposition, gas mixtures including one or more precursors are introduced into the processing chamber, and plasma is struck to activate chemical reactions. During etching, gas mixtures including etch gases are introduced into the processing chamber, and plasma is struck to activate chemical reactions. A computer-controlled robot typically transfers substrates from one processing chamber to another in a sequence in which the substrates are to be processed.

### SUMMARY

A system for printing a fully dense component of a nonmetallic material, the system comprises a chamber filled with an inert gas. A first vertically movable plate is arranged in the chamber to support a substrate. A second vertically movable plate is arranged adjacent to the first vertically movable plate. The second vertically movable plate is configured to store a powder of the nonmetallic material and to dose the substrate with the powder prior to printing each layer of the nonmetallic material. A laser generator is configured to supply a laser beam. A controller is configured to print a plurality of layers of the nonmetallic material on the substrate using the laser beam and to print a layer of the nonmetallic material on the plurality of layers to build the component on the plurality of layers by: printing a first sublayer of the layer of the nonmetallic material using the laser beam having a first power and a first speed and by printing a second sublayer of the layer of the nonmetallic material on the first sublayer using the laser beam having a second power and a second speed. The first speed is greater than the second speed. The first power is less than the second power.

In another feature, the nonmetallic material comprises particles having a diameter within a range of 0.5-100 μm.

In other features, the controller is further configured to print the first sublayer using the laser beam having a first orientation and to print the second sublayer using the laser beam having a second orientation that is different than the first orientation.

In another feature, the nonmetallic material is selected from a group consisting of silicon, silicon carbide, alumina, and ceramics.

In other features, the system further comprises one or more meshes having holes of different diameters and a vibrating system configured to vibrate the one or more meshes. The powder is selected from a stock by passing the stock through the one or more meshes. The selected powder comprises particles having a diameter within a range of 0.5-100 μm.

In another feature, the system further comprises a gas source configured to flow the inert gas through the chamber via an inlet and an outlet arranged proximate to the substrate in a direction opposite to a direction of the printing.

In another feature, the system further comprises a plate movement assembly configured to move the first vertically movable plate in a downward direction after printing each layer and to move the second vertically movable plate in an upward direction after printing each layer.

In still other features, a method of printing a fully dense component of a nonmetallic material on a substrate comprises printing a plurality of layers of the nonmetallic material on the substrate using a laser beam. The method further comprises printing a layer of the nonmetallic material on the plurality of layers to build the component on the plurality of layers by: printing a first sublayer of the layer of the nonmetallic material using the laser beam having a first power and a first speed and by printing a second sublayer of the layer of the nonmetallic material on the first sublayer using the laser beam having a second power and a second speed. The first speed is greater than the second speed. The first power is less than the second power.

In another feature, the nonmetallic material comprises particles having a diameter within a range of 0.5-100 μm.

In other features, the method further comprises printing the first sublayer using the laser beam having a first orientation and printing the second sublayer using the laser beam having a second orientation that is different than the first orientation.

In another feature, the nonmetallic material is selected from a group consisting of silicon, silicon carbide, alumina, and ceramics.

In another feature, the method further comprises supplying a dose of a powder of the nonmetallic material before printing each layer. The powder comprises particles having a diameter within a range of 0.5-100 μm.

In another feature, the method further comprises selecting the powder from a stock by passing the stock through one or more meshes having holes of different diameters and by vibrating the one or more meshes.

In another feature, the method further comprises flowing an inert gas proximate to the substrate in a direction opposite to a direction of the printing.

In another feature, the method further comprises printing the component in a chamber filled with an inert gas.

In still other features, a method of printing a component of a nonmetallic material on a substrate comprises printing a plurality of layers of the nonmetallic material on the substrate using a laser beam. The plurality of layers form a base on which to build the component. The method further comprises building the component on the plurality of layers by printing one or more layers of the nonmetallic material on the plurality of layers using the laser beam.

In another feature, the nonmetallic material comprises particles having a diameter within a range of 0.5-100 μm.

In other features, printing each layer of the one or more layers comprises printing a first sublayer of the nonmetallic material using the laser beam having a first power and a first speed and printing a second sublayer of the nonmetallic material on the first sublayer using the laser beam having a second power and a second speed. The first speed is greater than the second speed. The first power is less than the second power.

In other features, the method further comprises printing the first sublayer using the laser beam having a first orientation and printing the second sublayer using the laser beam having a second orientation that is different than the first orientation.

In another feature, the nonmetallic material is selected from a group consisting of silicon, silicon carbide, alumina, and ceramics.

In other features, the method further comprises supplying a dose of a powder of the nonmetallic material before printing each layer. The powder comprises particles having a diameter within a range of 0.5-100 μm.

In another feature, the method further comprises selecting the powder from a stock by passing the stock through one or more meshes having holes of different diameters and by vibrating the one or more meshes.

In another feature, the method further comprises flowing an inert gas proximate to the substrate in a direction opposite to a direction of printing.

In still other features, a method of printing a fully dense component of a nonmetallic material on a substrate comprises printing a first sublayer of a layer of the nonmetallic material on the substrate using a laser beam having a first power and a first speed. The method further comprises printing a second sublayer of the layer of the nonmetallic material on the first sublayer using the laser beam having a second power and a second speed. The first speed is greater than the second speed. The first power is less than the second power.

In another feature, the nonmetallic material comprises particles having a diameter within a range of 0.5-100 μm.

In other features, the method further comprises printing the first sublayer using the laser beam having a first orientation and printing the second sublayer using the laser beam having a second orientation that is different than the first orientation.

In another feature, the method further comprises printing a plurality of layers of the nonmetallic material on the substrate using the laser beam prior to printing the layer.

In another feature, the plurality of layers form a base on which the component is built by printing the layer.

In another feature, the nonmetallic material is selected from a group consisting of silicon, silicon carbide, alumina, and ceramics.

In another feature, the method further comprises supplying a dose of a powder of the nonmetallic material before printing each layer. The powder comprises particles having a diameter within a range of 0.5-100 μm.

In another feature, the method further comprises selecting the powder from a stock by passing the stock through one or more meshes having holes of different diameters and by vibrating the one or more meshes.

In another feature, the method further comprises flowing an inert gas proximate to the substrate in a direction opposite to a direction of the printing.

In still other features, a system for printing a fully dense and crack free component of a nonmetallic material on a substrate made of the nonmetallic material comprises a chamber for printing the fully dense and crack free component, the chamber being thermally insulated. The system further comprises a first vertically movable plate arranged in the chamber to support the substrate and a thermally insulating material arranged on a top surface of the first vertically movable plate and under the substrate. The system further comprises a heater configured to heat the substrate and a region of the chamber surrounding the substrate prior to printing the component on the substrate. The system further comprises a powder feeder configured to supply a powder of the nonmetallic material and a laser generator configured to supply a laser beam to print a layer of the nonmetallic material on the substrate while the heater continues to heat the substrate and the region of the chamber surrounding the substrate during the printing.

In another feature, the powder comprises particles having a diameter within a range of 0.5-100 μm.

In another feature, the heater is configured to heat the substrate and the region of the chamber surrounding the substrate to a temperature greater than a ductile to brittle transition temperature of the nonmetallic material during the printing of the component.

In another feature, after the printing, the heater is configured to continue heating the substrate and the region of the chamber surrounding the substrate while annealing the component in the chamber.

In another feature, after the printing, the component remains surrounded by the powder while the component slowly cools at a controlled rate.

In another feature, the chamber is thermally insulated with one or more of layers of one or more insulating materials.

In another feature, the nonmetallic material is selected from a group consisting of silicon, silicon carbide, alumina, and ceramics.

In another feature, the heater is arranged under the substrate or surrounding the substrate and the region of the chamber above the substrate.

In other features, the powder feeder comprises a second vertically movable plate arranged adjacent to the first vertically movable plate, and the second vertically movable plate is configured to store the powder and to dose the substrate with the powder prior to printing each layer of the nonmetallic material.

In another feature, the system further comprises a plate movement assembly configured to move the first vertically movable plate in a downward direction after printing each layer and to move the second vertically movable plate in an upward direction after printing each layer.

In another feature, the system further comprises one or more additional heaters configured to heat a region of the chamber above the substrate during the printing of the component.

In another feature, the powder feeder is configured to supply the powder along with the laser beam to print the layer of the component.

In another feature, the system further comprises a gantry system configured to move the first vertically movable plate while the powder feeder and the laser generator remain stationary during printing of each layer of the component.

In another feature, the chamber is under vacuum.

In another feature, the chamber is filled with an inert gas.

In another feature, the system further comprises a gas source configured to flow an inert gas through the chamber via an inlet and an outlet arranged proximate to the substrate in a direction opposite to a direction of the printing.

In other features, the system further comprises one or more meshes having holes of different diameters and a vibrating system configured to vibrate the one or more meshes. The powder is selected from a stock by passing the stock through the one or more meshes. The selected powder comprises particles having a diameter within a range of 0.5-100 μm.

In still other features, a method of printing a fully dense and crack free component of a nonmetallic material on a substrate made of the nonmetallic material in a chamber comprises heating the substrate and a region of the chamber surrounding the substrate prior to printing a layer of the nonmetallic material on the substrate. The method further comprises printing the layer of the nonmetallic material on the substrate using a laser beam while continuing to heat the substrate and the region of the chamber surrounding the substrate during the printing.

In another feature, the nonmetallic material comprises particles having a diameter within a range of 0.5-100 μm.

In another feature, the method further comprises heating the substrate and the region of the chamber surrounding the substrate to a temperature greater than a ductile to brittle transition temperature of the nonmetallic material during the printing of the component.

In another feature, the method further comprises after the printing, annealing and slow cooling the component in the chamber while continuing to heat the substrate and the region of the chamber surrounding the substrate.

In another feature, the method further comprises after the printing, cooling the component by surrounding the component with a powder of the nonmetallic material.

In another feature, the method further comprises thermally insulating the chamber using one or more of layers of one or more insulating materials.

In another feature, the nonmetallic material is selected from a group consisting of silicon, silicon carbide, alumina, and ceramics.

In other features, the method further comprises dosing the substrate with the nonmetallic material prior to printing each layer of the layer of the nonmetallic material, and supplying the laser beam subsequent to the dosing to print each layer of the nonmetallic material.

In another feature, the method further comprises heating a region of the chamber above the substrate during the printing of the component.

In another feature, the method further comprises supplying a powder of the nonmetallic material along with the laser beam to print each layer of the nonmetallic material.

In another feature, the method further comprises maintaining vacuum in the chamber.

In another feature, the method further comprises filling the chamber with an inert gas.

In another feature, the method further comprises flowing an inert gas proximate to the substrate in a direction opposite to a direction of the printing.

In other features, the method further comprises selecting a powder of the nonmetallic material from a stock by passing the stock through one or more meshes having holes of different diameters and by vibrating the one or more meshes. The selected powder comprises particles having a diameter within a range of 0.5-100 μm.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows an example of a substrate processing system comprising a processing chamber;

FIGS. 2A-2C show a powder bed based system for printing fully dense silicon materials on substrates according to the present disclosure;

FIG. 2D shows a system for selecting powders of nonmetallic materials for printing components using the systems and methods of the present disclosure;

FIG. 2E shows a system for manufacturing powder of a material such as silicon using plasma rotating electrode processing (PREP);

FIGS. 3A and 3B show a powder bed based method for printing fully dense nonmetallic materials on substrates according to the present disclosure;

FIGS. 4A and 4B show a powder bed based system for printing fully dense and crack free nonmetallic materials on nonmetallic substrates according to a high temperature powder bed method of the present disclosure;

FIG. 4C shows a powder bed based method for printing fully dense and crack free nonmetallic materials on nonmetallic substrates according to the high temperature powder bed method of the present disclosure;

FIGS. 5A-5C show a powder fed based system for printing fully dense and crack free components of nonmetallic materials on nonmetallic substrates according to the high temperature powder fed method of the present disclosure; and

FIG. 5D shows a powder fed based method for printing components of nonmetallic materials on nonmetallic substrates according to the high temperature powder fed method of the present disclosure.

In the drawings, reference numbers may be reused to identify similar and/or identical elements.

### DETAILED DESCRIPTION

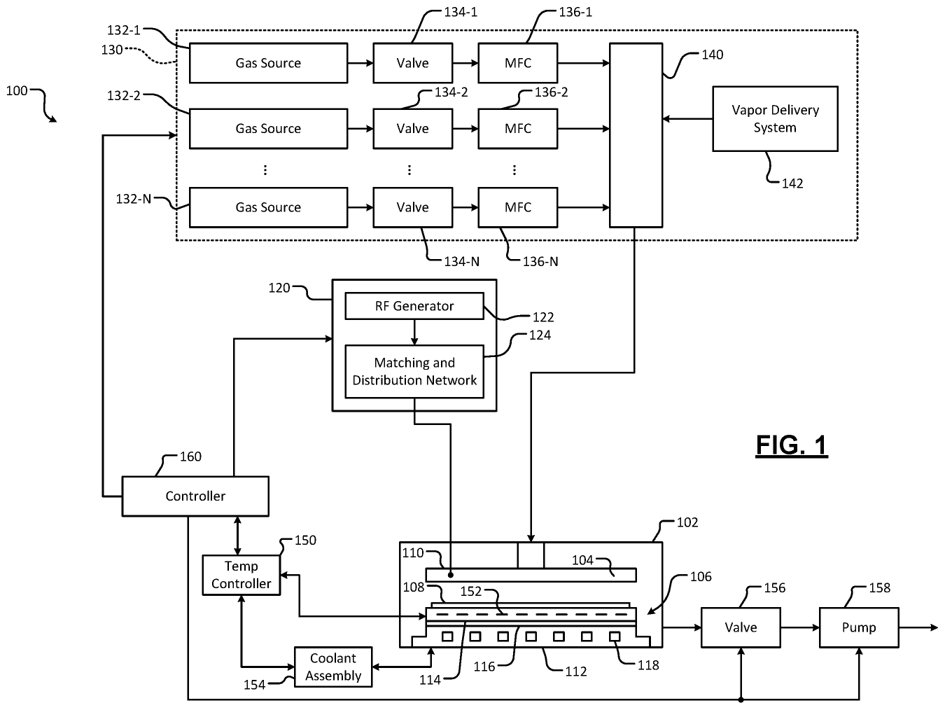

Various components used in substrate processing systems and processing chambers are manufactured with high precision. Some of these components are made of metals while others are made of materials such as silicon and ceramics. An example of a substrate processing system and a processing chamber is shown and described below with reference to FIG. 1 to provide examples of these components and the harsh electrical, chemical, and thermal environments in which these components operate.

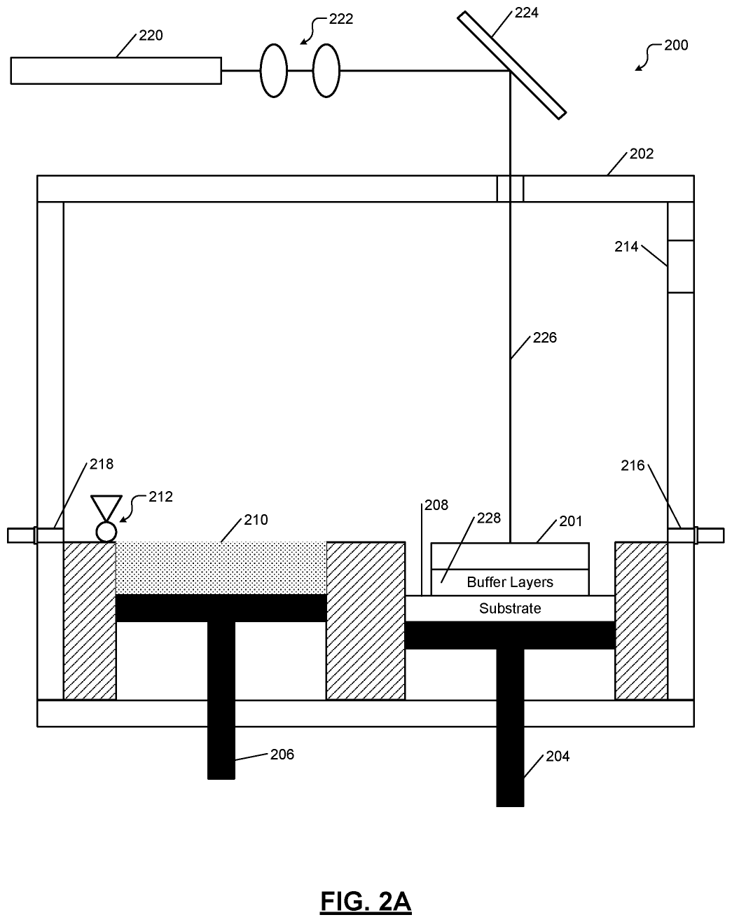

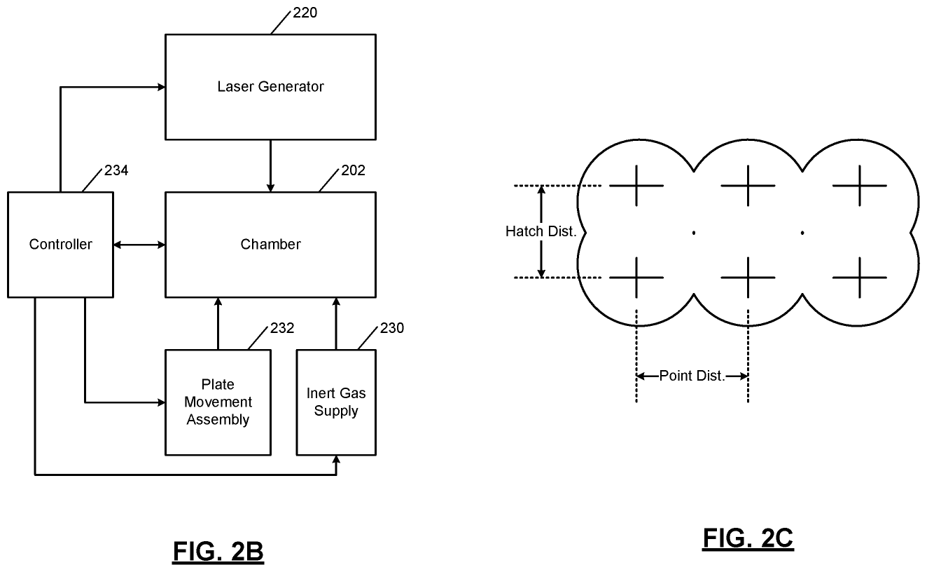

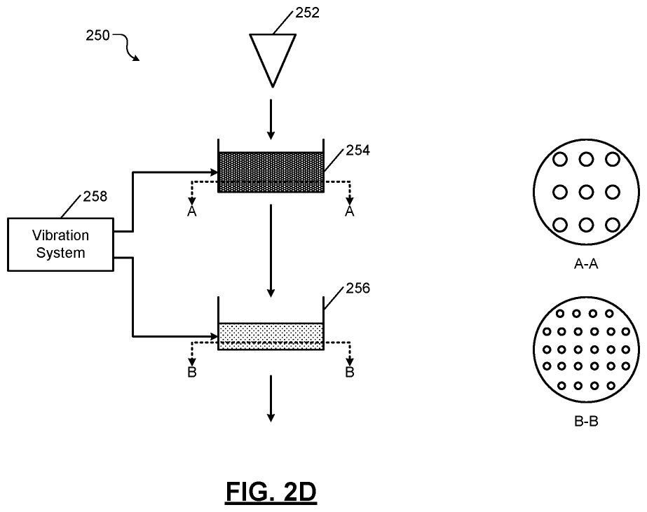

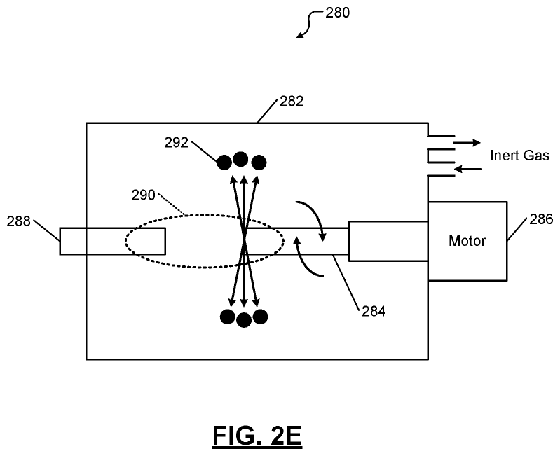

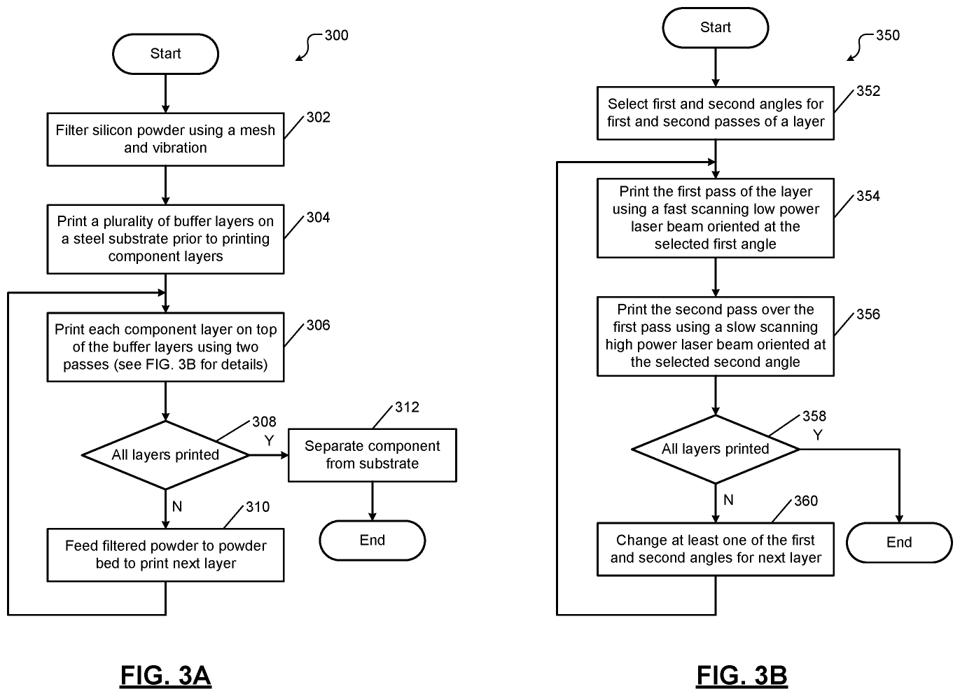

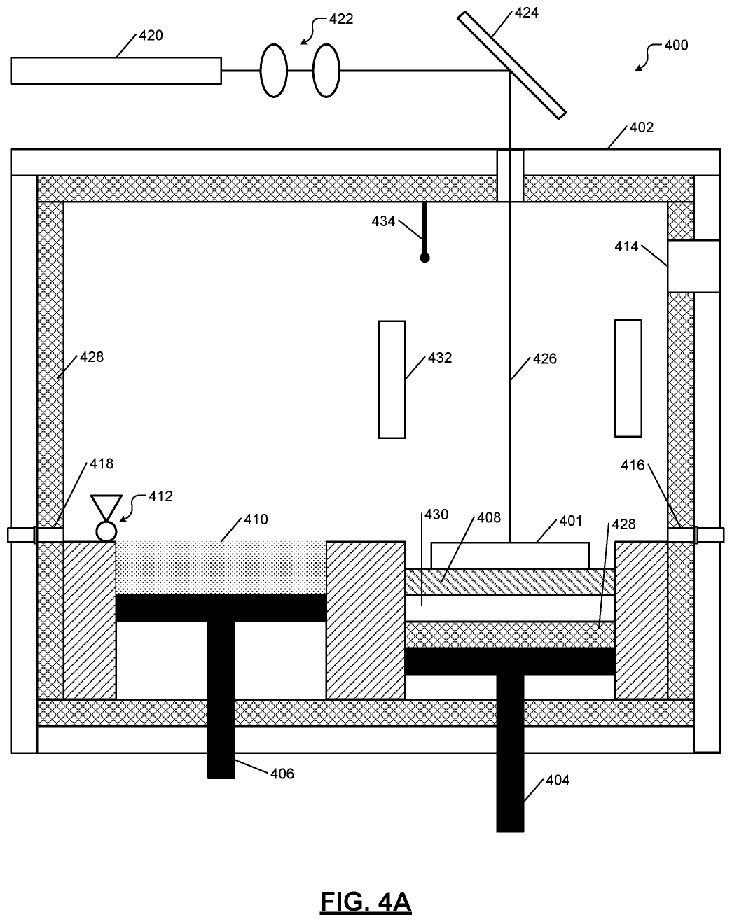

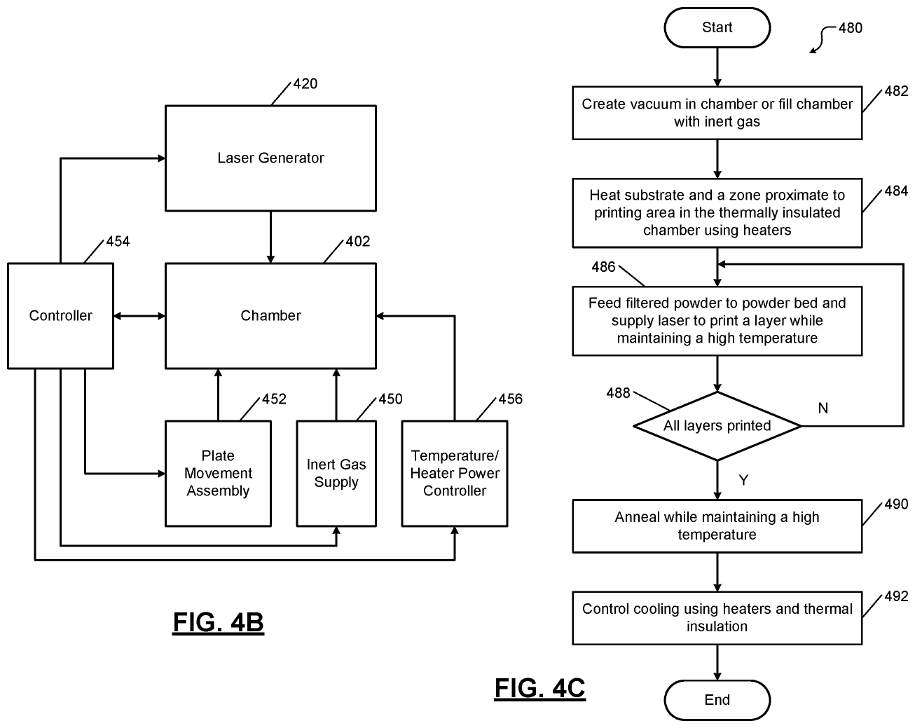

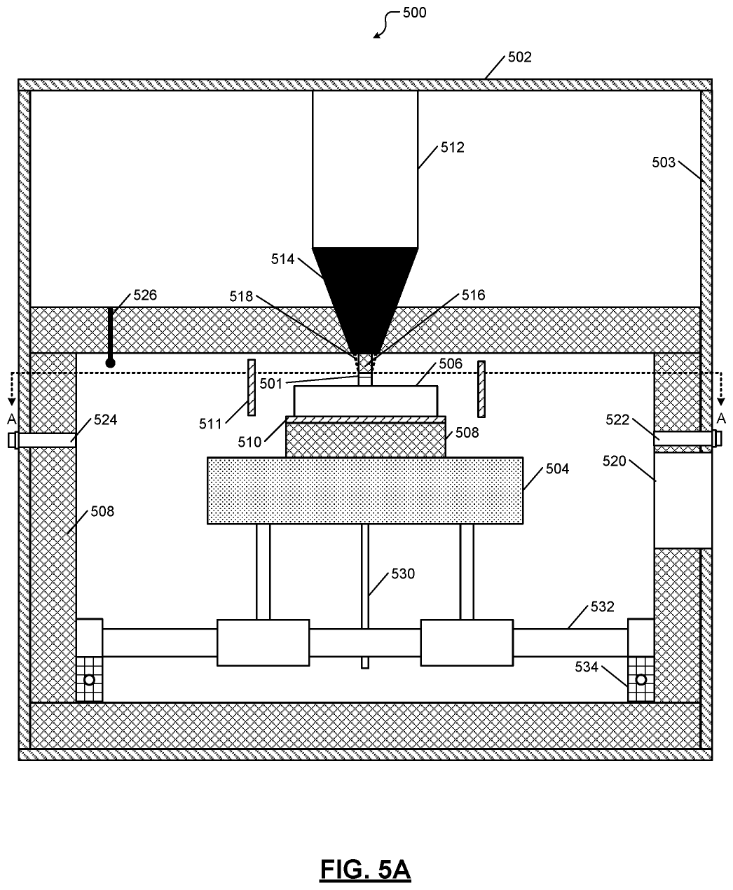

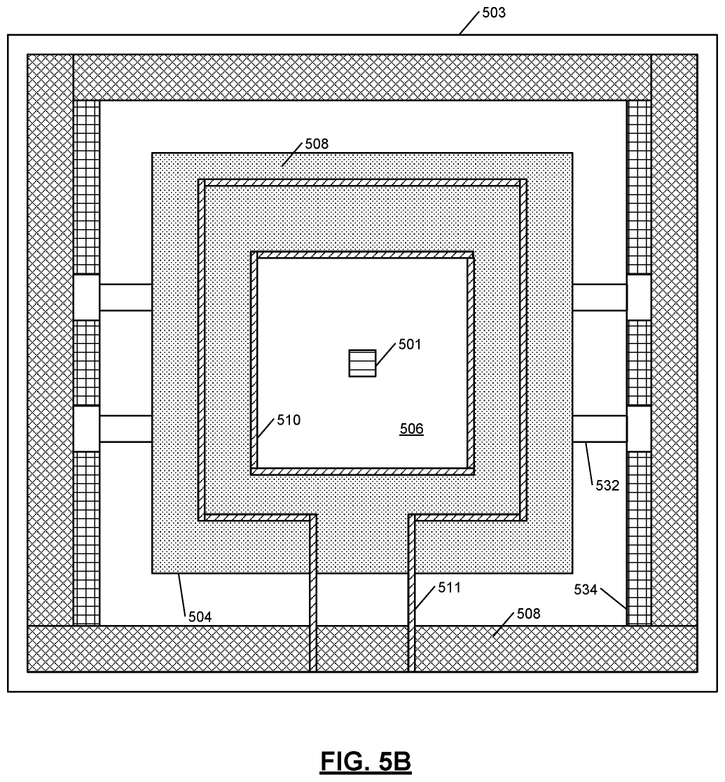

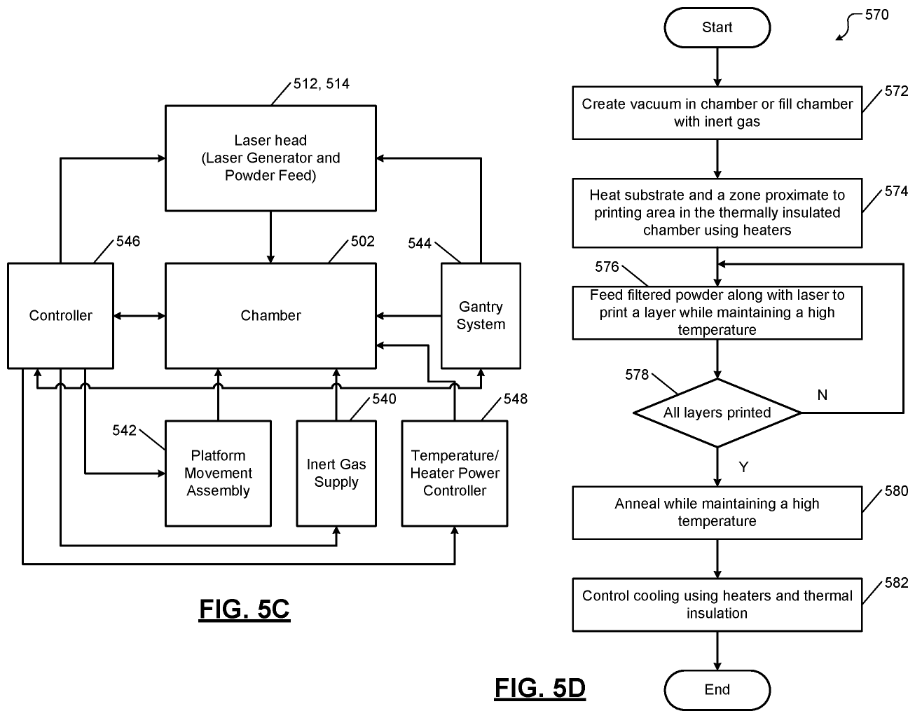

The present disclosure is organized as follows. Initially, an example of a substrate processing system including a processing chamber is shown and described with reference to FIG. 1. Subsequently, an overview of the systems and methods for 3D printing of silicon components according to a fully dense printing method and a crack free printing method is provided. Thereafter, systems and methods for 3D printing of fully dense silicon components according to the fully dense printing methods are described with reference to FIG. 2A-3B. Finally, systems and methods for 3D printing of fully dense and crack free silicon components according to the fully dense and crack free methods are described with reference to FIG. 4A-5D.

FIG. 1 shows an example of a substrate processing system 100 comprising a processing chamber 102. While the example is described in the context of plasma enhanced chemical vapor deposition (PECVD), the teachings of the present disclosure can be applied to other types of substrate processing such as atomic layer deposition (ALD), plasma enhanced ALD (PEALD), CVD, or other processing including etching processes. The system 100 comprises the processing chamber 102 that encloses other components of the system 100 and contains an RF plasma (if used). The processing chamber 102 comprises an upper electrode 104 and an electrostatic chuck (ESC) 106 or other substrate support. During operation, a substrate 108 is arranged on the ESC 106.

For example, the upper electrode 104 may include a gas distribution device 110 such as a showerhead that introduces and distributes process gases. The gas distribution device 110 may include a stem portion including one end connected to a top surface of the processing chamber 102. A base portion of the showerhead is generally cylindrical and extends radially outwardly from an opposite end of the stem portion at a location that is spaced from the top surface of the processing chamber 102. A substrate-facing surface or faceplate of the base portion of the showerhead includes a plurality of holes through which vaporized precursor, process gas, or purge gas flows. Alternately, the upper electrode 104 may include a conducting plate, and the process gases may be introduced in another manner.

The ESC 106 comprises a baseplate 112 that acts as a lower electrode. The baseplate 112 supports a heating plate 114, which may correspond to a ceramic multi-zone heating plate. A thermal resistance layer 116 may be arranged between the heating plate 114 and the baseplate 112. The baseplate 112 may include one or more channels 118 for flowing coolant through the baseplate 112.

If plasma is used, an RF generating system 120 generates and outputs an RF voltage to one of the upper electrode 104 and the lower electrode (e.g., the baseplate 112 of the ESC 106). The other one of the upper electrode 104 and the baseplate 112 may be DC grounded, AC grounded, or floating. For example only, the RF generating system 120 may include an RF generator 122 that generates RF power that is fed by a matching and distribution network 124 to the upper electrode 104 or the baseplate 112. In other examples, the plasma may be generated inductively or remotely.

A gas delivery system 130 includes one or more gas sources 132-1, 132-2, . . . , and 132-N (collectively gas sources 132), where N is an integer greater than zero. The gas sources 132 are connected by valves 134-1, 134-2, . . . , and 134-N (collectively valves 134) and mass flow controllers 136-1, 136-2, . . . , and 136-N (collectively mass flow controllers 136) to a manifold 140. A vapor delivery system 142 supplies vaporized precursor to the manifold 140 or another manifold (not shown) that is connected to the processing chamber 102. An output of the manifold 140 is fed to the processing chamber 102.

A temperature controller 150 may be connected to a plurality of thermal control elements (TCEs) 152 arranged in the heating plate 114. The temperature controller 150 may be used to control the plurality of TCEs 152 to control a temperature of the ESC 106 and the substrate 108. The temperature controller 150 may communicate with a coolant assembly 154 to control coolant flow through the channels 118. For example, the coolant assembly 154 may include a coolant pump, a reservoir, and one or more temperature sensors (not shown). The temperature controller 150 operates the coolant assembly 154 to selectively flow the coolant through the channels 118 to cool the ESC 106. A valve 156 and pump 158 may be used to evacuate reactants from the processing chamber 102. A system controller 160 controls the components of the system 100.

As can be appreciated, the components used in substrate processing systems and processing chambers (e.g., showerheads) need to be manufactured with high precision. Some of these components are made of metals while others are made of materials such as silicon and ceramics. As explained below, 3D printing of components made of materials such as silicon and ceramics is very challenging due to their brittle nature which causes cracks using conventional 3D printing systems, and the present disclosure provides a solution for addressing the challenges and for 3D printing of fully dense and crack free components made of materials such as silicon and ceramics.

Briefly, in the fully dense printing method, the present disclosure describes systems and methods for printing fully dense silicon components using 3D printing technology (additive manufacturing). The 3D printing technology of the present disclosure is powder bed based selective laser melting (SLM) that uses a single laser beam to melt silicon powder on a build plate (i.e., a building platform or a substrate). Unlike 3D printing of metal-based materials, the systems and methods of the present disclosure address factors that affect printing quality when printing fully dense silicon components. The present disclosure describes particle morphology, size, and distribution of silicon powder and also describes a printing strategy, an appropriate laser power and printing speed, and a bed preheating strategy. All of these techniques contribute to printing fully dense silicon components using 3D printing. The systems and methods of the present disclosure can print large silicon components with complex internal features which cannot be accomplished using traditional subtractive machining methods.

Additionally, in the crack free printing method, the present disclosure describes a design of a 3D printing equipment with a low temperature gradient. The design uses one or multiple heaters along with good thermal insulation in a vacuum chamber to minimize a temperature gradient during printing of a silicon component, in-situ annealing, and cooling. Using the heaters and the insulation, a uniform high temperature with a low thermal gradient is maintained throughout the equipment and throughout the printing process. The heaters can be either resistive or inductive heaters, IR lamp radiation heaters, or blue light heaters (e.g., using blue LEDs). The insulation material can be rigid carbon fiber insulation, soft graphite felt, or a combination of both. Due to high reactivity of carbon and melted silicon with oxygen at elevated temperatures, the equipment needs to be vacuum tight. Silicon is preferably printed in a vacuum chamber or in a chamber filled with an inert gas (e.g., Ar or He).

The low thermal gradient method according to the crack free printing method can be used for powder fed or powder bed laser printing methods. Due to the brittle nature of silicon materials, the substrate temperature for 3D printing is preferably greater than the ductile to brittle transition temperature (DBTT) of silicon (e.g., >1000° C.) during printing and annealing of the silicon component to prevent thermal stress buildup. This way, silicon is ductile during printing. The printed component is also preferably cooled slowly at a controlled rate.

In the low thermal gradient method according to the crack free printing method, silicon is a preferred substrate for 3D printing of silicon components to avoid a mismatch of coefficient of thermal expansion (CTE), which can occur if non-silicon substrates are used, and which can lead to component cracking. Silicon is the preferred substrate over substrates of other material such as metals for an additional reason: to prevent contamination due to impurity diffusion from the non-silicon material into silicon, which can occur at high temperatures using during printing and annealing. Accordingly, using the crack free method of the present disclosure, silicon components with high purity and low thermal stress (e.g., crack free) can be printed. The crack free printing methodology of the present disclosure can be applied to other brittle materials such as alumina, silicon carbide, ceramics, and so on.

More specifically, the fully dense printing method addresses the following concerns for 3D printing of silicon. Current additive manufacturing technology for silicon is based on direct energy deposition (DED). Voids or pores exist in the printed silicon samples due to insufficient laser energy density or strong spatter ejection in the current printing process.

Accordingly, the fully dense printing method of the present disclosure describes using a steel substrate since a silicon substrate can crack and chip due to the thermal impact applied to the substrate during printing. The cracks can propagate in Z direction which may fracture the printed sample. A steel substrate is used to avoid the damage to the printed silicon sample. Since the melting point of steel is higher than that of silicon, steel does not melt during silicon printing.

Additionally, in the fully dense printing method, a plurality of buffer layers of silicon are initially printed on the steel substrate, and then layers of silicon for the actual component are printed on top of the buffer layers. The buffer layers are printed at a faster rate than the rate at which the subsequent silicon layers are printed on the buffer layers to print the component. This reduces a coefficient of thermal expansion (CTE) mismatch between the steel substrate and the silicon layers printed on the buffer layers. Without the buffer layers, a large CTE mismatch can exist between the steel substrate and the silicon layers printed directly on the steel substrate to manufacture a component, which can lead to fracture in the printed component. The buffer layers reduce CTE mismatch that can occur between the steel substrate and the silicon layers printed to build the component if the layers are printed directly on the steel substrate without the intervening buffer layers.

Further, in the fully dense printing method, the silicon layers are printed on the buffer layers using a double printing method as follows. Each silicon layer printed on the buffer layer is printed twice (i.e., using two passes). In a first printing or pass, the layer is printed at a faster speed (i.e., with a shorter exposure time of laser beam) using a lower power laser beam than the speed and power used in a second printing or pass. During the first printing, the lower power does not fully melt the silicon but binds the silicon particles together. Subsequently, during the second printing, the slower speed and higher power of the laser beam scanning the material from the first pass with a longer exposure time fully melts the already bonded silicon particles from the first pass, thus forming a fully dense layer of silicon. Thus, the first printing pass can be called a sintering pass, and the second printing pass can be called a melting pass.

Furthermore, in each layer, the orientation of the laser beam in the first pass can be different than in the second pass to even out thermal stress in each layer. For example, suppose three layers A, B, and C are to be printed, and each layer is printed using two passes P1 and P2. Let m and n respectively denote the angle or orientation of the laser beam in degrees during passes P1 and P2 in the X-Y plane along the substrate. For layer A, (m, n)=(0, 90); for layer B, (m, n)=(45, −45); and for layer C, (m, n)=(90, 0). The pattern is repeated for subsequent layers. This effectively reduces thermal stress across the layers and prevents the cracking in the printed component.

The double printing method of the first solution also reduces spatter ejection, which typically involves bright (melted airborne) particles of silicon blown away from the melting pool due to an inert gas flowing at the bottom of the printing chamber. These particles cool down in flight and land on the downwind printed sample. These particles might not be fully melted during the printing of the next layer, which can cause voids or porosity in the component printed using traditional printing methods. In contrast, in the double printing method, the first printing pass binds these ejected particles to each other and to the silicon particles, which are then fully melted during the second printing pass. Further, since a lower power laser beam is used during the first pass, the amount of spatter ejection is reduced, and whatever spatter ejection occurs during the first pass is fully melted during the second pass.

Furthermore, any spatter ejection occurring during the second pass is also fully melted due to the use of a slow high power laser beam. Specifically, the area recently printed is still hot enough to melt any ejected particles landing in the area. Additionally, if any ejected particles land in the area to be printed, these particles are fully melted by the high power laser beam as printing continues and reaches the area. Thus, a fully dense component without porosity is manufactured using the double printing method.

In the fully dense printing method, before printing, the silicon powder is preferably filtered (i.e., sorted) using a mesh to obtain particles having size in a relatively narrow range. For example only, the range can be 0.5-100 μm. As another example, the range can be 15-45 μm. This ensures that the particles have spherical shape and smooth surface and that there is no particle aggregation. That is, the filtered powder flows and spreads better in the powder bed on the substrate than the unfiltered powder. When the gas atomized unfiltered powder is poured in the mesh for filtering, the filter size of the mesh is selected, and the mesh is vibrated mechanically. For example, the mesh can be vibrated mechanically or using ultrasound.

After printing, the component is separated from the steel substrate by cutting through the buffer layer, for example. The buffer layers are relatively easy to cut through, which is an additional benefit of using the buffer layers. The separated steel substrate can be refinished and prepared to receive new buffer layers to manufacture a next component.

In the fully dense printing method, due to the use of the buffer layers and the double printing method, a large CTE mismatch between the steel substrate and the printed silicon is reduced and voids in the printed silicon are eliminated. For example, while a few initial layers are being printed on the buffer layers, the buffer layers reduce CTE mismatch between the steel substrate and the layers being printed, which prevents fracturing of the printed silicon. However, a large thermal stress still exists in the printed silicon samples whenever using the fully dense printing method in the conventional metal 3D printers which do not have a high temperature hot zone. All the printed silicon samples in the conventional metal 3D printers have micro-cracks with no exception.

To eliminate the micro-cracks in the printed silicon, a new 3D printing equipment design with a low temperature gradient is described in the present disclosure. The design uses a vacuum chamber with one or multiple heaters along with good thermal insulation to minimize the temperature gradient during Si part printing, in-situ annealing, cooling. The heaters can be either resistive or inductive heaters, IR lamp radiation heaters, or blue light heaters (e.g., using blue LEDs). The insulation materials can be either rigid carbon fiber insulation or soft graphite felt or combination of both. Because of high reactivity of carbon and Si melt with oxygen at elevated temperatures, the system is enclosed in a vacuum tight environment. For example, the printing is carried out in a vacuum chamber or in a chamber filled with an inert gas (e.g., Ar or He). The low thermal gradient method can be used for powder fed or powder bed laser printing method.

Due to the brittle nature of silicon materials, the substrate temperature for 3D printing is preferably greater than the DBTT of silicon (e.g., >1000° C.) during printing and annealing of the silicon component to prevent thermal stress buildup. The printed component is also cooled slowly. A silicon substrate is preferred for printing silicon components to avoid CTE mismatch. The methodology can be applied to other brittle materials, such as silicon carbide (SiC), ceramics, alumina, and so on.

The new 3D printing equipment is designed for printing brittle materials, such as silicon, silicon carbide, alumina, and other ceramics. Presently, the conventional 3D printing equipment is designed for printing metals which are ductile materials and are more tolerant to thermal stress. Therefore, ex-situ annealing can be used to reduce thermal stress. However, the current 3D printing equipment is not capable of uniformly heating and maintaining high substrate temperatures (e.g., >600° C.), and large temperature gradient occurs while printing silicon components, where melt pool temperature is >1414° C., which is the melting point of silicon. In addition, the cool down in the currently used 3D printing processes is fast and not controlled. The large temperature gradient during printing and cooling down of silicon components leads to micro-cracks in all 3D-printed silicon samples using the conventional metal 3D printers (either powder bed or powder fed printing, with or without buffer layers). No crack free printed silicon samples have been observed using 3D metal printers. The micro-cracks cannot be healed in ex-situ annealing.

Accordingly, the crack free printing method of the present disclosure describes using one or multiple heaters along with good thermal insulation to minimize the temperature gradient during Si printing, in-situ annealing, and cooling. The heaters can be either resistive or inductive heaters, IR lamp radiation heaters, or blue light heaters (e.g., using blue LEDs). The insulation materials can be either rigid carbon fiber insulation or soft graphite felt or combination of both. Because of high reactivity of carbon and Si melt with oxygen at elevated temperatures, the system uses a vacuum tight chamber. For example, silicon components are printed in a vacuum chamber or in a chamber filled with an inert gas (e.g., Ar or He).

As described below with reference to FIGS. 4A-5D, according to the crack free printing method, the chamber can be rectangular with rigid insulation plates covering the inside at top and bottom, left and right, front and back. Alternatively, the chamber can be cylindrical with rigid insulation plates covering the inside at top and bottom and a rigid insulation cylinder shielding the surrounding cylindrical wall. The insulation plates and cylinder can also be made of multiple layers, such as rigid insulation/rigid insulation, graphite/rigid insulation, rigid insulation/felt, graphite/felt, carbon fiber composite (CFC)/felt. Felt is essentially a cloth-like soft material made of many layers of carbon fiber. Felt prevents heat from escaping and helps in maintaining the high temperature uniform throughout the printing process (i.e., felt helps in maintaining a low thermal gradient throughout the printing process).

In the crack free silicon printing method, graphite resistive heaters are preferred and schematically laid out as shown in FIGS. 4A-5D described below. One or more graphite susceptors (i.e., shields) could be placed inside the side heaters to protect the heaters. The silicon powder is dosed by a powder wiper after completion of each layer of printing. When the printing of all layers is completed, the printed samples are embedded into silicon powder. Silicon powder has low thermal conductivity and reduces heat transfer between the printed components.

Due to the brittle nature of silicon materials, the substrate temperature is preferred to be greater than the DBTT point of silicon (e.g., >1000° C.) during printing of the silicon component (so that silicon is ductile during printing) and during annealing to prevent thermal stress buildup. The annealing temperatures are preferably between 1100-1200° C. The cool down is preferably at a rate<5° C./min from annealing temperature to 400° C. and is followed by backfill of an inert gas (e.g., Ar). The substrate for 3D printing Si is preferably made of Si materials to avoid CTE mismatch and contaminations. The methodology can be used to print components of other brittle materials such as ceramics, silicon carbide, alumina, and so on.

Accordingly, by using heaters and insulation, the crack free printing method of the present disclosure maintains a low temperature gradient during printing and in-situ annealing as well as provides a slow cool down at a controlled rate, which significantly reduces thermal stress and eliminates micro-cracking in the printed Si components. In contrast, the conventional metal 3D printing equipment is not capable of maintaining temperatures above 600° C. and controlled cool down, which induces high thermal stress and causes micro-cracks in the printed Si part and renders it useless. Further, unlike the conventional metal 3D printing equipment, the printing method of the present disclosure uses a vacuum tight chamber to prevent oxidation of Si melt, and uses graphite based heaters and carbon fiber based thermal insulations.

These and other features of the present disclosure are now described below in details. FIGS. 2A-3B show the systems and methods according to the fully dense printing method of the present disclosure. FIGS. 4A-5D show the systems and methods according to the crack free printing method of the present disclosure.

FIG. 2A shows a system 200 for 3D printing a component 201 of a nonmetallic material such as silicon on a metal substrate according to the fully dense printing method of the present disclosure. The system 200 comprises a chamber 202. The chamber 202 comprises a first plate 204 and a second plate 206. The first plate 204 supports a substrate 208 on which a component is printed. Accordingly, the first plate 204 is also called a building plate, a building platform, a printing plate, or another suitable name.

The second plate 206 stores the nonmetallic material 210 (e.g., silicon powder). A dose bar or a powder wiper 212 supplies the nonmetallic material 210 to the substrate 208 prior to printing each layer. Accordingly, the second plate 206 is also called a feeding plate, a dosing plate, or another suitable name.

The chamber 202 comprises an observation window 214. The observation window 214 is coated with a film to reduce heat dissipation. The chamber 202 also comprises an inlet 216 and an outlet 218 for supplying an inert gas proximate to the substrate 208 during printing. The direction of flow of the inert gas is opposite to the printing direction.

The system 200 further comprises a laser generator 220, lenses 222, and a mirror 224 to direct a laser beam 226 onto the substrate 208 during printing. In the example shown, the inert gas flows from right to left, and the printing direction is from left to right. Of course, these directions can be reversed so long as the directions of printing and gas flow are opposite.

FIG. 2B shows additional elements of the system 200. The system 200 further comprises an inert gas supply 230 to supply the inert gas to the chamber 202. The system 200 further comprises a plate movement assembly 232 to move the first plate 204 downwards and to move the second plate 206 upwards during printing. The system 200 further comprises a controller 234 that controls all the elements of the system 200 as explained below.

For example, the system 200 uses a selective laser melting (SLM) printing technology based printer and silicon powder manufactured by plasma rotating electrode processing (PREP, described with reference to FIGS. 2D and 2E below) to print silicon in a layer by layer manner. For example, a 400 W ytterbium fiber laser may be used. For example, a diameter of a focus spot of the laser beam 426 may be 70 μm. The laser energy is delivered to a focus plane (i.e., the horizontal plane of the top surface of the build plate 204) via a point-by-point exposure methodology.

FIG. 2C schematically shows how the laser beam 226 delivers energy on the focus plane (the build plate 204). Each circle shown is a schematic projection of the laser beam 226 on the focus plane and may have a diameter of 70 μm, for example. The laser beam 226 dwells on each circle for a short time called an exposure time and then moves to a horizontally neighboring circle (next column) in a row. The moving distance is called a point distance (e.g., 80 μm) as shown in FIG. 2C.

After completing the row, the laser beam moves to a next row. This moving distance is called a hatch distance (e.g., 60 μm) as shown in FIG. 2C. The melting of silicon powder in each circle occurs when the laser beam 226 is dwelling on the circle (within the exposure time). In this process, depending on the laser power and the exposure time, the laser beam 226 creates a melting pool of silicon whose size is approximately 1.5˜2 times the size of the circle and is about 2˜3 layers deep. Therefore, the silicon powder particles are well covered by the melting pool so that they can be melted as the laser beam 226 scans in the X-Y plane. The combination of laser beam power, exposure time, the point distance, and the hatch distance determines the energy density of the 3D printing. As this process continues, all the selected silicon powder in this layer is melted. The process continues until all the layers are completed.

In the present disclosure, the 3D printing of silicon is controlled from aspects of silicon powder, printing strategy, and thermal stress as follows. The silicon powder is manufactured via plasma rotating electrode processing (PREP) method which produces silicon powder with highly spherical silicon particles, and which is described with reference to FIGS. 2D and 2E below. Each individual silicon particle has a smooth surface and does not have particle aggregation. For example, the particle size ranges between 0.5-100 μm. As another example, the particle size can range between 15-45 μm.

FIG. 2D shows an example of a system 250 for selecting silicon powder from a stock of silicon powder manufactured using PREP. The system 250 comprises a feeder 252 that feeds the stock of silicon powder manufactured using PREP, which is described with reference to FIG. 2E below. The system 250 comprises a first mesh 254 arranged vertically above a second mesh 256. As shown in sections A-A and B-B of the first and second meshes 254, 256, the holes of the first mesh 254 have a diameter d1 that is greater than a diameter d2 of the holes of the second mesh 256.

The feeder 252 feeds the stock of the silicon powder manufactured using PREP into the first mesh 254. A vibrating system 258 vibrates the first and second meshes 254, 256. For example, the vibrating system 258 may vibrate the first and second meshes 254, 256 mechanically or using ultrasound. At the end of the sieving process carried out by the vibration, silicon powder having particles with diameters between d1 and d2 remain in the second mesh 256, which are used as the nonmetallic material 210 for printing the component 201.

For example, the holes of the first mesh 254 may be of the size 88 μm, the holes of the second mesh 256 may be of the size 53 μm. The first mesh 254 screens out too big particles (e.g., of size>88 μm). The second mesh 256 screens out too small particles (e.g., of size<53 μm). The powder left in the second mesh 256 is collected for printing. The particles in the collected powder flow smoothly without clogging the powder supply hose (not shown) of the powder fed printer.

Alternatively, in a simplified powder screening process, only one mesh with holes of a selected size (e.g., 63 μm) may be used along with the vibration system 258 to screen out big particles (e.g., of size>63 μm). In this way, silicon powder whose size is less than the selected size (e.g., 63 μm) can be obtained and used for printing. Some particles of size less than the selected size (e.g., 40 μm˜60 μm) may not be able to pass through the sieve (i.e., the mesh). In this example, eventually, the majority of the powder particles are of size less than 40 μm while the best particle size for printing may be around 32 μm.

In general, it is understood that the mesh sizes can be selected depending on the particle sizes desired. For example, if the particle size is desired to be between x and y μm, where y>x, the diameter d1 of the first mesh 254 should be y or more (i.e., d1≥y), and the diameter d1 of the first mesh 254 should be y or more (i.e., d1≤x).

Accordingly, the two mesh solution may be used without constraints on how the powder stock is manufactured (i.e., the stock need not be manufactured using PREP). The single mesh solution may be used with atomized powder feed stock when any particle size less than the diameter of the mesh holes is acceptable. In general, using either solution, silicon powder having size in a relatively narrow range (e.g., 0.5-100 μm) can be selected for printing. As another example, using either solution, silicon powder having size in a range of 15-45 μm can be selected for printing.

FIG. 2E shows a system 280 for manufacturing powder of a material such as silicon using the plasma rotating electrode processing (PREP) method. The system 280 comprises a chamber 282. An inert gas is circulated through the chamber 282. An electrode 284 made of a material of which powder is to be manufactured (e.g., silicon) is coupled to a shaft of a motor 286. A plasma torch 288 heats a distal end of the electrode 284 to strike plasma 290 as the motor 286 is rotated. As a result, the distal end of the electrode 284 melts into molten liquid. The molten liquid is crushed into droplets 292 that are ejected by the centrifugal force of the rotating electrode 284. The droplets 292 solidify into powder. The powder thus manufactured using the PREP method is used as feedstock in the systems and methods of the present disclosure.

The particle size distribution (PSD) of a powder or granular material such as the powder manufactured using the PREP method described above is a list of values or a mathematical function that defines the relative amount, typically by mass, of particles present according to size. The most common method of determining PSD is sieve analysis where powder is separated on sieves of different sizes (e.g., as described with reference to FIG. 2D above). Thus, the PSD is defined in terms of discrete size ranges: for example, “% of sample between 45 μm and 53 μm”, when sieves of these sizes are used. The PSD is usually determined over a list of size ranges that covers nearly all the sizes present in the sample. Some methods of determination allow much narrower size ranges to be defined than can be obtained by using sieves, and are applicable to particle sizes outside the range available in sieves. However, the notion of a sieve that retains particles above a certain size and passes particles below that size is commonly used in presenting PSD data.

The PSD may be expressed as a range analysis in which the amount in each size range is listed in order. The PSD may also be presented in cumulative form in which the total of all sizes retained or passed by a single notional sieve is given for a range of sizes. Range analysis is suitable when a particular ideal mid-range particle size is being sought while cumulative analysis is used where the amount of under-size or over-size is to be controlled.

Before a PSD can be determined, a representative sample is obtained. In the case where the material to be analyzed is flowing, the sample is withdrawn from the stream in such a way that the sample has the same proportions of particle sizes as the stream. Preferably many samples of the whole stream are taken over a period instead of taking a portion of the stream for the whole time. After sampling, the sample volume typically needs to be reduced. The material to be analyzed is blended and the sample is withdrawn using techniques that avoid size segregation (e.g., using a rotary divider).

Various PSD measurement techniques may be used to measure the particle size of the silicon powder used in the systems and methods of the present disclosure. Some examples of the PSD measurement techniques are described below. For example, sieve analysis is a simple and inexpensive technique. Sieve analysis methods may include simple shaking of the sample in sieves until the amount retained becomes more or less constant. This technique is well-suited for bulk materials.

Alternatively, materials can be analyzed through photo-analysis procedures. Unlike sieve analyses which can be time-consuming and sometimes inaccurate, taking a photo of a sample of the materials to be measured and using software to analyze the photo can result in rapid, accurate measurements. Another advantage is that the material can be analyzed without being handled.

In other examples, PSDs can be measured microscopically by sizing against a graticule and counting. For a statistically valid analysis, millions of particles are measured. Automated analysis of electron micrographs is used to determine particle size within the range of 0.2 to 100 μm.

Coulter counter is an example of electro-resistance counting methods that can measure momentary changes in conductivity of a liquid passing through an orifice that take place when individual non-conducting particles pass through. The particle count is obtained by counting pulses. This pulse is proportional to the volume of the sensed particle. Very small sample aliquots can be examined using this method.

Other examples include sedimentation techniques. These techniques are based on study of terminal velocity acquired by particles suspended in a viscous liquid. These techniques determine particle size as a function of settling velocity. Sedimentation time is longest for the finest particles. Accordingly, this technique is useful for sizes below 10 μm. Sub-micrometer particles cannot be reliably measured due to the effects of Brownian motion. A typical measuring apparatus disperses the sample in liquid, then measures the density of the column at timed intervals. Other techniques determine the optical density of successive layers using visible light or x-rays.

Laser diffraction methods depend on analysis of the halo of diffracted light produced when a laser beam passes through a dispersion of particles in air or in a liquid. The angle of diffraction increases as particle size decreases. Accordingly, this method is particularly good for measuring sizes between 0.1 and 3,000 μm. Due to advances in data processing and automation, this is the dominant method used in industrial PSD determination. This technique is relatively fast and can be performed on very small samples. This technique can generate a continuous measurement for analyzing process streams. Laser diffraction measures particle size distributions by measuring the angular variation in intensity of light scattered as a laser beam passes through a dispersed particulate sample. Large particles scatter light at small angles relative to the laser beam and small particles scatter light at large angles. The angular scattering intensity data is then analyzed to calculate the size of the particles responsible for creating the scattering pattern using the Mie theory or Fraunhofer approximation of light scattering. The particle size is reported as a volume equivalent sphere diameter.

In laser obscuration time (LOT) or time of transition (TOT) method, a focused laser beam rotates at a constant frequency and interacts with particles within the sample medium. Each randomly scanned particle obscures the laser beam to a dedicated photo diode, which measures the time of obscuration. The time of obscuration t directly relates to the particle's diameter D by the equation D=V*t, where V is the beam rotation velocity.

In acoustic spectroscopy or ultrasound attenuation spectroscopy, instead of light, this ultrasound is used to collect information on the particles that are dispersed in fluid. Dispersed particles absorb and scatter ultrasound. Instead of measuring scattered energy versus angle, as with light, in the case of ultrasound, measuring the transmitted energy versus frequency is a better choice. The resulting ultrasound attenuation frequency spectra are the raw data for calculating particle size distribution. It can be measured for any fluid system with no dilution or other sample preparation. Calculation of particle size distribution is based on theoretical models that are well verified for up to 50% by volume of dispersed particles. As concentration increases and the particle sizes approach nanoscale, conventional modelling need to include shear-wave re-conversion effects to accurately reflect the real attenuation spectra.

After the silicon powder produced by the PREP system shown in FIG. 2E is sieved using the system shown in FIG. 2D, the PSD of the silicon particles is determined using one or more of the PSD measurement techniques described above. The powder selected for use in the systems and methods of the present disclosure is denser and more spherical. For example, 90 wt. % of the powder has the particle size in the range of 0.5-100 μm (or, in another example, in the range of 15-45 μm), defined as volume-based particle size D=2*[3*V/(4*π)]\hat{ }(1/3)). While the term sphere or spherical is used to describe the particles' shape, at least 90% particles have a volume-based particle size that is not more than 5% less than the measured longest diameter (measured using a microscope).

The printing is performed as follows. The controller 234 creates an inert printing atmosphere in the chamber 202 for printing silicon. Specifically, the silicon printing process starts with the controller 234 drawing a vacuum to remove the air and moisture in the chamber 202. Then the controller 234 fills the chamber 202 with an inert gas (e.g., argon) from the inert gas supply 230 to avoid oxidation of silicon during printing. The controller 234 circulates the inert gas from one end (e.g., 216) to another (e.g., 218) at the bottom of the chamber 202. The flow of the inert gas blows spatter ejection particles away from the printed samples as described below.

A silicon substrate can fracture and chip due to thermal impact during printing. The cracks can propagate in z direction, which may break the printed component 201. Therefore, a steel substrate 208 is used to avoid the damage that can occur to the printed component when the silicon substrate is used to print the silicon component. The melting point of steel is higher than that of silicon and therefore does not melt during silicon printing. Steel is only one example for the substrate material; many other metals, alloys, and non-brittle materials can be used instead as the substrate 208 so long as the melting point of the material used for the substrate is greater than the melting point of silicon (or of the nonmetallic material 210 used to print the component 201).

An energy density of the laser is computed to define the intensity of the laser energy. Specifically, the energy density is equal to (Laser power×Exposure time)/(Point distance×Hatch distance). This equation gives the 2D energy density without considering the layer thickness of the powder and defines the intensity of the laser energy in the X-Y plane.

In the present disclosure, the layer thickness is set to such a value (e.g., 30 μm) that only 2D energy density is needed to calculate the intensity of the laser energy. Too low of an energy density can lead to a small size of a melted pool that is unable to melt all the powder particles in a layer. The un-melted silicon powder creates discontinuous melting pools during cooling, which increases the surface roughness and pores in the current layer. This occurs when the energy density is less than 5 μJ/μm², for example.

As the energy density increases, the size of the melting pool increases, and the melted droplets have better flowability. The printed component has less pores, and the relative density of the printed component increases. This corresponds to energy density level between 5˜14 μJ/μm², for example. However, if the energy density is increased further, the silicon powder can be over-burnt, and the printed component can lose its geometry accuracy.

In the present disclosure, for printing silicon, the controller 234 may set the energy density in a range between 10˜14 μJ/μm², for example. The silicon powder fully melts and the printed silicon components are fully dense when the energy density is set in this range.

A plurality of layers (e.g., about fifty layers) of silicon, called buffer layers 228, are initially printed on the steel substrate 208. Each layer of the buffer layers 228 is printed once and is printed quickly (i.e., with fast laser scanning). For example, the laser power may be set to 200 W, and the exposure time may be set to 50 μs. In this example, the corresponding energy density is only 2.1 μJ/μm². Due to the low energy density, some of the silicon powder may not fully melt. However, the purpose of the buffer layers 228 is not to fully melt the silicon powder. Rather, as already explained above in detail, the buffer layers 228 can avoid inconsistency of thermal expansion between the steel substrate 208 and the lower layers of printed silicon component 201 that are subsequently printed on top of the buffer layers 228.

After printing the buffer layers 228, the printing of the component 201 begins. The component 201 is printed on top of the buffer layers 228 using double printing for each layer of the component 201. For example, the laser power in the first printing of a layer (also called printing a first sublayer) may be set to 240 W (higher than that used to printer the buffer layers 228), and the exposure time may be set to 50 μs (i.e., the first sublayer is also printed quickly; approximately similarly to the buffer layers 228).

The second printing of the layer (also called printing the second sublayer) repeats the path of the first printing. The laser power and exposure time are increased (e.g., to 350 W and 150 μs) during the second printing. Accordingly, the energy density for printing the second sublayer is greater than the energy density for printing the first sublayer. For example, using the above examples of laser power and exposure times, the energy densities for the printing of the two sublayers of each layer may be 2.5 μJ/μm² and 11.0 μJ/μm² respectively.

The first printing (i.e., the printing of the first sublayer) melts some of the silicon powder in this layer and also defines the geometry of the component 201. Then the second printing fully melts all of the silicon powder left un-melted in the first printing. The higher energy density in the second printing also elevates the temperature of the printed silicon component 201 to a high level for slow cooling in the fast heating-cooling cycles in printing. The slow cooling of the currently printed layer serves a similar thermal purpose for subsequently printed layers as that served by the buffer layers 228 for the currently printed layer.

The controller 234 selects the energy density of the second printing such that the silicon powder fully melts and over-burning of the silicon powder is also avoided. This double printing method also protects the printed components from contamination due to spatter ejection of particles, thus avoiding pores induced by the spatter ejection, which is described below.

Spatter ejection occurs when bright (hot) particles of silicon (or the nonmetallic material 210) are ejected away from the melting pool due to recoil pressure during printing of each layer. These particles cool down in flight and may land in the downwind direction (in the direction of flow of the inert gas) on the printed component. For example, as shown in FIG. 2A, argon may flow from right bottom (216) to left bottom (218) of the chamber 202, and the laser beam 226 may scan from left to right so that the spatter ejection particles are blown to the left of the layer being printed (in the downwind direction). Accordingly, some of the ejected particles may land on the left side of the layer being printed when the laser beam 226 moves from left to right. The landed spatter ejection particles are generally bigger than the size of the silicon powder and might not be fully melted by the laser beam during printing of the next layer. This can cause porosity problem and reduce the strength of the printed component.

Spatter ejection can be caused by high energy density and/or low printing speed. According to the present disclosure, the double printing method of printing a layer prints the first sublayer of the layer with a low energy density laser beam to define the geometry in first printing. The low energy density (e.g., 2.5 μJ/μm²) and high printing speed (e.g., 1300 mm/s) reduces the intensity of spatter ejection. Most of the silicon powder is melted in this step and solidified around the un-melted silicon powders after the laser beam 226 stops. This prevents the un-melted powder from spattering by the recoil pressure. Then the second printing (i.e., the printing of the second sublayer on top of the first sublayer) with a high energy density laser beam and slower printing speed than the first printing fully melts all the un-melted silicon powder, and the intensity of spatter ejection is substantially reduced. The double printing strategy effectively reduces the intensity of spatter ejection, which significantly minimizes or eliminates porosity problem caused by spatter ejection.

FIG. 3A shows a method 300 for printing a component of a nonmetallic material on a metal substrate using buffer layers and double printing according to the present disclosure. FIG. 3B shows the double printing method 350 in further detail. For example, the methods 300 and 350 are performed by the controller 234.

In FIG. 3A, at 302, the method 300 filters or screens a stock of silicon powder manufactured using PREP by using one or more meshes and a vibration system (e.g., as shown in FIG. 2D). At 304, the method 300 prints a plurality of buffer layers of the nonmetallic material on the metal substrate prior to printing the component layers. At 306, the method 300 prints each component layer on top of the buffer layers using the double printing method 350 shown in detail in FIG. 3B.

At 308, the method 300 determines if all the layers of the component are printed. At 310, if all the layers of the component are not yet printed (i.e., if printing of the component is not yet completed), the method 300 feeds the filtered or screened powder of the nonmetallic material to the powder bed to print the next layer of the component; and the method 300 returns to 306. At 312, if all the layers of the component are printed (i.e., if printing of the component is completed), the method 300 separates the printed component of the nonmetallic material from the metal substrate; and the method 300 ends.

FIG. 3B shows the double printing method 350 in further detail. At 352, the method 350 selects first and second angles for printing first and second sublayers of a layer of the component. At 354, the method 352 prints, in a first pass, the first sublayer of the layer of the component using a fast scanning, low-power laser beam oriented at the selected first angle. At 356, the method 352 prints, in a second pass, the second sublayer of the layer of the component using a slow scanning, high-power laser beam oriented at the selected second angle.

At 358, the method 350 determines if all the layers of the component are printed. At 360, if all the layers of the component are not yet printed (i.e., if printing of the component is not yet completed), the method 350 changes at least one of the first and second angles to be used for printing the next layer of the component; and the method 350 returns to 354. The method 350 ends if all the layers of the component are printed (i.e., if printing of the component is completed).

Thus, the advantages of the system 200 and the method 300 according to the first solution of the present disclosure include the following. The powder of the nonmetallic material manufactured using PREP has much higher quality as compared to the powders traditionally manufactured with gas atomization. The particles of the powder manufactured using PREP are also highly spherical and have smooth surfaces. Accordingly, the flowability and spreadability of the powder made using PREP are much better than those of the powder made using gas atomization. Further, the diameter of the particles is controlled and selected using one or more meshes and vibration as explained above.

The metal (e.g., steel) substrate protects the printed silicon component from fracturing. Ideally, silicon substrate is the only or preferred candidate as the substrate material. However, silicon substrate can fracture when subjected to high thermal load (or high temperature gradient) during printing, and the cracks can propagate through the printed silicon component causing fracturing. Steel being a ductile material can withstand the high temperature gradient and does not fracture.

The buffer layers reduce the CTE mismatch between the steel substrate and the printed silicon (i.e., between metal substrate and nonmetallic layers of the component being printed on the metal substrate). Further, the first printing (i.e., printing the first sublayer of each layer of the component) defines the component geometry. Most of silicon powder is melted in the first printing. The dissipation of melting pool restrains the un-melted silicon powder surrounded by the melted silicon. Therefore, spatter ejection is substantially reduced together with fast printing speed in the first printing. This avoids pores or voids in the printed component that can be induced by spatter ejection. Then the second printing fully melts all the un-melted silicon powder and elevates the component temperature to a high level before the printing of the next layer starts.

FIGS. 4A-4C show a powder bed based system and method for 3D printing a component of a nonmetallic brittle material on a substrate of the same nonmetallic material according to the crack free printing method of the present disclosure. FIG. 4A shows a powder bed based system 400 for 3D printing a component 401 of a nonmetallic material on a substrate of the same nonmetallic material. The system 400 comprises a chamber 402. The chamber 402 comprises a first plate 404 and a second plate 406. The first plate 404 supports a substrate 408 on which the component 401 is printed. Accordingly, the first plate 404 is also called a building plate, a building platform, a printing plate, or another suitable name.

The second plate 406 stores the nonmetallic material 410. A dose bar or a powder wiper 412 supplies the nonmetallic material 410 to the substrate 408 prior to printing each layer. Accordingly, the second plate 406 is also called a feeding plate, a dosing plate, or another suitable name.

The chamber 402 comprises an observation window 414. The observation window 414 is coated with a film to reduce heat dissipation. The chamber 402 also comprises an inlet 416 and an outlet 418 for supplying an inert gas proximate to the substrate 408 during printing. The direction of flow of the inert gas is opposite to the printing direction. In the example shown, the inert gas flows from right to left, and the printing direction is from left to right. Of course, these directions can be reversed so long as the directions of printing and gas flow are opposite. The system 400 further comprises a laser generator 420, lenses 422, and a mirror 424 to direct a laser beam 426 onto the substrate 408 during printing.

The chamber 402 is thermally insulated with an insulating material 428. The insulating material 428 is described below in further detail. A heater 430 is used to heat the substrate 408 before and during the printing of the component 401. A layer of the insulating material 428 is arranged between the top of the first plate 404 and the bottom of the heater 430. One or more heaters 432 are used to heat the region surrounding the substrate 408 during printing. A temperature sensor 434 is used to sense the temperature of the region surrounding the substrate 408. The heaters 430, 432 are controlled based on the sensed temperature.

FIG. 4B shows additional elements of the system 400. The system 400 further comprises an inert gas supply 450 to supply the inert gas to the chamber 402. The system 400 further comprises a plate movement assembly 452 to move the first plate 404 downwards and to move the second plate 406 upwards during printing. The system 400 further comprises a power supply and a temperature controller (shown as temperature/heater power controller 456) to maintain the desired temperatures inside the hot zone. The system 400 further comprises a controller 454 that controls all the elements of the system 400 as explained below.

Current 3D printing equipment is designed for printing metals which are ductile materials and are more tolerant to thermal stress. Therefore, ex-situ annealing can be used to reduce thermal stress. However, the current conventional 3D printing equipment is not capable of uniform heating and maintaining substrate temperatures greater than about 600° C. Accordingly, large temperature gradients can occur in the silicon component being printed in these machines since the melt pool temperature is greater than the melting point of silicon (1414° C.), and adjacent silicon (i.e., silicon adjacent to the melt pool) is likely at temperatures<700 C. In addition, in the current 3D printing equipment, the cool down is fast and not controlled. The large temperature gradient during printing and fast cooling down lead to micro-cracks in the 3D-printed silicon components using conventional 3D printers. The micro-cracks cannot be healed in ex-situ annealing.

Therefore, the system 400 provides the 3D printing equipment with a low temperature gradient. The system 400 uses one or multiple heaters 430, 432 along with thermal insulation (i.e., the insulating material 428) to minimize the temperature gradient during printing, in-situ annealing, and cooling. The heaters 430, 432 can be either resistive or inductive heaters, infrared (IR) lamp radiation heaters, or blue light heaters (e.g., using blue LEDs). The insulating material 428 can be either rigid carbon fiber insulation or soft graphite felt or combination of both. Due to high reactivity of carbon and melted silicon with oxygen at elevated temperatures during printing, the system 400 needs to be vacuum tight. It is preferred to print in vacuum or in an inert environment, where the chamber 402 is filled with an inert gas (e.g., Ar, He).

In one embodiment, chamber 402 is rectangular in shape with rigid insulation plates (i.e., rigid plates of the insulating material 428) covering the inside at top and bottom, left and right, front and back. In another embodiment, the chamber 402 is cylindrical in shape with rigid insulation plates covering the inside at top and bottom and rigid insulation cylinder shielding the surrounding cylindrical wall. Other shapes are contemplated.

The insulation plate or cylinder can be made of multiple layers, such as rigid insulation/rigid insulation, graphite/rigid insulation, rigid insulation/felt, graphite/felt, carbon fiber composite (CFC)/felt. Felt is essentially a cloth-like soft material made of many layers of carbon fiber. Insulation prevents heat from escaping and helps in maintaining the high temperature uniformly throughout the printing process (i.e., insulation and heaters help in maintaining a low thermal gradient throughout the printing process).

For 3D printing of silicon, graphite resistive heaters are preferred. A graphite susceptor (i.e., a shield, not shown) can be placed inside the side heater 432 to protect the heater 432. The silicon powder is selected as described in the fully dense printing method, and the selection process is therefore not repeated for brevity. The silicon powder is dosed by the powder wiper 412 after completion of printing of each layer. When the printing of all layers is completed, the printed component 401 is embedded in silicon powder. The silicon powder can also prevent heat from dissipating in the horizontal direction. The silicon powder has low thermal conductivity and slightly slows cooling of the printed component.

Due to the brittle nature of silicon, the substrate temperature for 3D printing is preferred to be greater than the ductile to brittle transition temperature or DBTT of silicon (i.e., greater than 1000° C.) during printing and annealing of the printed component 401 to prevent thermal stress buildup. For example, the annealing temperatures are preferred to be between 1100-1200° C. It is also preferred to cool down the printed component 401 slowly at a controlled rate. For example, the cool down is preferred to be at a rate of less than 5° C./min from the annealing temperature to about 400° C., and is followed by backfill of an inert gas (e.g., Ar). The substrate 408 for 3D printing of the component 401 of silicon is preferably made of silicon to avoid CTE mismatch between the substrate 408 and the component 401 and contamination from substrates made of other materials. The concept can be applied to other brittle materials such as alumina, silicon carbide, ceramics, etc.

FIG. 4C shows a powder bed based method 480 for 3D printing a component (e.g., element 401) of a nonmetallic material on a substrate (e.g., element 408) of the same nonmetallic material according to the second solution of the present disclosure. For example, the method 480 is performed by the controller 454.

At 482, the method 480 creates vacuum in a thermally insulated chamber or fills a thermally insulated chamber (e.g., the chamber 402) with an inert gas (e.g., argon). At 484, before starting the printing of the component 401, the method 480 heats the substrate 408 and a region proximate to the printing area (i.e., surrounding the substrate 408) using one or more heaters (e.g., heaters 430, 432).

At 486, the method 480 feeds filtered or screened silicon powder to form a powder bed on the substrate 408. The method 480 supplies a laser beam 426 to print a layer of the silicon powder while maintaining the heat provided by the one or more heaters 430, 432. The method 480 senses the temperature in the chamber 402 (e.g., of the region surrounding the substrate) and maintains the temperature of the substrate 408 and the surrounding region to a temperature greater than the DBTT of the silicon (or the nonmetallic material being used to print the component).

At 488, the method 480 determines if all the layers of the component 401 are printed (i.e., if the printing of the component is completed). The method 480 returns to 486 if all the layers of the component 401 are not yet printed (i.e., if the printing of the component is not yet completed).

At 490, the method 480 anneals the printed component 401 while maintaining the heat supplied by the heaters 430, 432 under the control of the controller 454. At 492, under the control of the controller 454, the method 480 controls the annealing and the cooling of the printed component 401 using the heaters 430, 432, the insulation 428, and using the silicon powder surrounding the printed component, and the method 480 ends.

FIGS. 5A-5D show a powder fed based system and method for 3D printing a component of a nonmetallic material on a substrate of the same nonmetallic material according to the crack free printing method of the present disclosure. FIG. 5A shows a powder fed based system 500 for 3D printing a component 501 of a nonmetallic material on a substrate of the same nonmetallic material.

The system 500 comprises a chamber 502. The chamber 502 has a wall 503. The chamber 502 is thermally insulated with an insulating material 508. The chamber 502 comprises a platform 504. A substrate 506 of a nonmetallic material such as silicon is arranged on the platform. A rigid graphite insulating material 508 is arranged between the bottom surface of the substrate 506 and the top surface of the platform 504. A heater 510 is arranged above the insulating material 508. The heater 510 is placed underneath the substrate 506 and heats the substrate 506 before and during the printing of the component 501.

To print or repair a large component, a large hot zone with uniform temperature field is needed. Only one heater 510 at the bottom of substrate 506 may not be enough to provide the large uniform temperature field in the printing region. Therefore, an additional heater 511 is arranged above the substrate 506 to heat the substrate 506 and a region of the chamber 502 above the substrate 506 during the printing of the component 501. Thus, one or more heaters can be arranged either at the bottom of the substrate 506, or surrounding the substrate 506 and the region above it, or both.

A laser head (also called a printing head) 512 has a conical tip 514 through which the laser head 512 supplies a laser beam 516. The laser head 512 also supplies a powder 518 of the nonmetallic material through the conical tip 514 such that the powder 518 surrounds the laser beam 516. The laser beam 516 and the powder 518 are directed to (i.e., are incident on) the substrate 506 during printing.

The chamber 502 comprises an observation window 520. The observation window 520 is coated with a film to reduce heat dissipation. The chamber 502 also comprises an inlet 522 and an outlet 524 for supplying an inert gas proximate to the substrate 506 during printing. The direction of flow of the inert gas is opposite to the printing direction. In the example shown, the inert gas flows from right to left, and the printing direction is from left to right. Of course, these directions can be reversed so long as the directions of printing and gas flow are opposite. The chamber 502 further comprises a temperature sensor 526 that senses the temperature in the vicinity of the substrate 506 throughout the printing process. The heater 510 is controlled based on the sensed temperature.

The platform 504 (and therefore the substrate 506) can be raised or lowered vertically along the axis of the laser head 512 using a z axis lead screw 530. The platform 504 (and therefore the substrate 506) can be moved along the x and y axes using x and y axis gantries 532, 534, respectively. FIG. 5B shows a section A-A of the chamber 502.

FIG. 5C shows additional elements of the system 500. The system 500 further comprises an inert gas supply 540 to supply the inert gas to the chamber 502. The system 500 further comprises a platform movement assembly 542 to move the platform 504 (and therefore the substrate 506) vertically upwards and downwards. The system 500 further comprises a gantry system 544 to move the platform 504 (and therefore the substrate 506) along x and y axes. The system 500 further comprises a power supply and temperature controller (shown as temperature/heater power controller 548) to maintain the desired temperatures inside the hot zone. The system 500 further comprises a controller 546 that controls all the elements of the system 500 as explained below.

The system 500 provides the 3D printing equipment with a low temperature gradient. The system 500 uses the heater 510 along with thermal insulation (i.e., the insulating material 508) to minimize the temperature gradient during printing, in-situ annealing, and cooling. The heater 510 can be either resistive or inductive heaters, infrared (IR) lamp radiation heaters, or blue light heaters (e.g., using blue LEDs). The insulating material 508 can be either rigid carbon fiber insulation or soft graphite felt or combination of both. Due to high reactivity of carbon and melted silicon with oxygen at elevated temperatures during printing, the system 500 needs to be vacuum tight. It is preferred to print in vacuum or in an inert environment, where the chamber 502 is filled with an inert gas (e.g., Ar, He).

The silicon powder is selected as described in the fully dense printing method, and the selection process is therefore not repeated for brevity. The silicon powder 518 is dosed along with the laser beam 516 during printing of each layer.

Due to the brittle nature of silicon, the substrate temperature for 3D printing is preferred to be greater than the DBTT (i.e., greater than 1000° C.) during printing and annealing of the printed component 501 to prevent thermal stress buildup. For example, the annealing temperatures are preferred to be between 1100-1200° C. It is also preferred to cool down the printed component 501 slowly. For example, the cool down is preferred to be at a rate of less than 5° C./min from the annealing temperature to about 400° C., and is followed by backfill of an inert gas (e.g., Ar). The substrate 506 for 3D printing of the component 501 of silicon is preferably made of silicon to avoid CTE mismatch between the substrate 506 and the component 501 and potential contamination from substrates made of other materials. The concept can be applied to other brittle materials such as alumina, silicon carbide, ceramics, etc.

FIG. 5D shows a powder fed based method 570 for 3D printing a component 501 of a nonmetallic material on a substrate 506 of the same nonmetallic material according to the crack free printing method of the present disclosure. For example, the method 570 is performed by the controller 546.

At 572, the method 570 creates vacuum in a thermally insulated chamber or fills a thermally insulated chamber (e.g., the chamber 502) with an inert gas (e.g., argon). At 574, before starting the printing of the component 501, the method 570 heats the substrate 506 and a region proximate to the printing area (i.e., surrounding the substrate 506) using one or more heaters (e.g., heater 510).

At 576, the method 570 feeds filtered or screened silicon powder 518 along with a laser beam 516 to print a layer of the silicon powder on the substrate 506 while maintaining the heat provided by the one or more heaters 510. The method 570 senses the temperature in the chamber 502 (e.g., of the region surrounding the substrate) and maintains the temperature of the substrate 506 and the surrounding region to a temperature greater than the DBTT of the silicon (or the nonmetallic material being used to print the component).

At 578, the method 570 determines if all the layers of the component 501 are printed (i.e., if the printing of the component is completed). The method 570 returns to 576 if all the layers of the component 501 are not yet printed (i.e., if the printing of the component is not yet completed).

At 580, the method 570 anneals the printed component 501 while maintaining the heat supplied by the heaters 510 under the control of the controller 546. At 582, under the control of the controller 546, the method 570 controls the cooling of the printed component 501 using the heaters 510, insulation 508 and using the silicon powder 518 surrounding the printed component 501, and the method 570 ends.

Thus, the systems 400, 500 and methods 480, 570 according to the crack free printing method includes adding heaters and thermal insulation to the metal 3D-printing equipment, which enables maintaining a lower temperature gradient during printing and in-situ annealing as well as slower cool down at a controlled cooling rate, which significantly reduces thermal stress in the printed silicon component and eliminates micro-cracks.

The conventional metal 3D printing equipment is not capable of maintaining temperatures above 600° C. and controlled cool down, which induces high thermal stress and causes micro-cracks in the printed silicon component and renders it useless. The solution also uses vacuum tight chamber to prevent oxidation of melted silicon, graphite based heaters, and carbon fiber based thermal insulations. The conventional metal 3D printing equipment does not require vacuum tight or inert environment.

In the powder fed system 500, the printing head 512 is stationary, and the substrate 506 and the platform 504 are moved using x, y, and z axis gantry system 544 during printing under the control of the controller 546. The printing head 512 is protected by graphite felt (shown black around the conical tip 514) from thermal damage. After printing each layer, the substrate 506 and the platform 504 moves down one layer in z direction until printing is completed. The observation window 520 is coated with a film to reduce heat dissipation. The temperature inside the chamber 502 is controlled for high temperature printing, annealing, and slow cooling to avoid micro-cracking under the control of the controller 546.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate.

The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software).

The program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process.

In some examples, a remote computer (e.g. a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control.

Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

1. A system for printing a fully dense component of a nonmetallic material, the system comprising:
a chamber filled with an inert gas;
a first vertically movable plate arranged in the chamber to support a substrate;
a second vertically movable plate arranged adjacent to the first vertically movable plate, wherein the second vertically movable plate is configured to store a powder of the nonmetallic material and to dose the substrate with the powder prior to printing each layer of the nonmetallic material;
a laser generator configured to supply a laser beam; and
a controller configured to print a plurality of layers of the nonmetallic material on the substrate using the laser beam and to print a layer of the nonmetallic material on the plurality of layers to build the component on the plurality of layers by:
printing a first sublayer of the layer of the nonmetallic material using the laser beam having a first power and a first speed; and
printing a second sublayer of the layer of the nonmetallic material on the first sublayer using the laser beam having a second power and a second speed;
wherein the first speed is greater than the second speed; and
wherein the first power is less than the second power.

2. The system of claim 1 wherein the nonmetallic material comprises particles having a diameter within a range of 0.5-100 μm and wherein the diameter is measured using sieve analysis.

3. The system of claim 1 wherein the controller is further configured to:
print the first sublayer using the laser beam having a first orientation; and
print the second sublayer using the laser beam having a second orientation that is different than the first orientation.

4. The system of claim 1 wherein the nonmetallic material is selected from a group consisting of silicon, silicon carbide, alumina, and ceramics.

5. The system of claim 1 further comprising:
one or more meshes having holes of different diameters; and
a vibrating system configured to vibrate the one or more meshes;
wherein the powder is selected from a stock by passing the stock through the one or more meshes; and
wherein the selected powder comprises particles having a diameter within a range of 0.5-100 μm which is measured using sieve analysis.

6. The system of claim 1 further comprising a gas source configured to flow the inert gas through the chamber via an inlet and an outlet arranged proximate to the substrate in a direction opposite to a direction of the printing.

7. The system of claim 1 further comprising a plate movement assembly configured to move the first vertically movable plate in a downward direction after printing each layer and to move the second vertically movable plate in an upward direction after printing each layer.

8-35. (canceled)

36. A system for printing a fully dense and crack free component of a nonmetallic material on a substrate made of the nonmetallic material, the system comprising:
a chamber for printing the fully dense and crack free component, the chamber being thermally insulated;
a first vertically movable plate arranged in the chamber to support the substrate;
a thermally insulating material arranged on a top surface of the first vertically movable plate and under the substrate;
a heater configured to heat the substrate and a region of the chamber surrounding the substrate prior to printing the component on the substrate;
a powder feeder configured to supply a powder of the nonmetallic material; and
a laser generator configured to supply a laser beam to print a layer of the nonmetallic material on the substrate while the heater continues to heat the substrate and the region of the chamber surrounding the substrate during the printing.

37. The system of claim 36 wherein the powder comprises particles having a diameter within a range of 0.5-100 μm and wherein the diameter is measured using sieve analysis.

38. The system of claim 36 wherein the heater is configured to heat the substrate and the region of the chamber surrounding the substrate to a temperature greater than a ductile to brittle transition temperature of the nonmetallic material during the printing and annealing of the component.

39. The system of claim 36 wherein after the printing, the heater is configured to continue heating the substrate and the region of the chamber surrounding the substrate while annealing the component in the chamber.

40. The system of claim 36 wherein after the printing, the component remains surrounded by the powder while the component slowly cools at a controlled rate.

41. The system of claim 36 wherein the chamber is thermally insulated with one or more of layers of one or more insulating materials.

42-52. (canceled)

53. A method of printing a fully dense and crack free component of a nonmetallic material on a substrate made of the nonmetallic material in a chamber, the method comprising:
heating the substrate and a region of the chamber surrounding the substrate prior to printing a layer of the nonmetallic material on the substrate; and
printing the layer of the nonmetallic material on the substrate using a laser beam while continuing to heat the substrate and the region of the chamber surrounding the substrate during the printing.

54. The method of claim 53 wherein the nonmetallic material comprises particles having a diameter within a range of 0.5-100 μm, and wherein the diameter is measured using sieve analysis.

55. The method of claim 53 further comprising heating the substrate and the region of the chamber surrounding the substrate to a temperature greater than a ductile to brittle transition temperature of the nonmetallic material during the printing and annealing of the component.

56. The method of claim 53 further comprising after the printing, annealing and slow cooling the component in the chamber while continuing to heat the substrate and the region of the chamber surrounding the substrate.

57. The method of claim 53 further comprising after the printing, cooling the component by surrounding the component with a powder of the nonmetallic material.

58. The method of claim 53 further comprising thermally insulating the chamber using one or more of layers of one or more insulating materials.

59. The method of claim 53 wherein the nonmetallic material is selected from a group consisting of silicon, silicon carbide, alumina, and ceramics.

60. The method of claim 53 further comprising:
dosing the substrate with the nonmetallic material prior to printing each layer of the layer of the nonmetallic material; and
supplying the laser beam subsequent to the dosing to print each layer of the nonmetallic material.

61-67. (canceled)
